(19) United States
(12) Patent Application Publication
(10) Pub. No.: US 2019/0197506 A1
(43) Pub. Date: Jun. 27, 2019

(54) MERCHANT SERVICE FOR REAL-TIME SETTLEMENT APPARATUS AND METHOD

(71) Applicants: Robert Jay McShirley, Oxnard, CA (US); Kyle Taylor, Oxnard, CA (US); Richard Shirley, Oxnard, CA (US)

(72) Inventors: Robert Jay McShirley, Oxnard, CA (US); Kyle Taylor, Oxnard, CA (US); Richard Shirley, Oxnard, CA (US)

(21) Appl. No.: 16/129,242

(22) Filed: Sep. 12, 2018

Related U.S. Application Data
(60) Provisional application No. 62/558,713, filed on Sep. 14, 2017.

(51) Int. Cl. G06Q 20/16; G06Q 20/02; G06Q 20/40

(52) U.S. Cl. CPC G06Q 20/16; G06Q 20/4016; G06Q 20/02

(57) ABSTRACT

A system and method that enables merchants to settle credit card batches in real time. The system and method may be customized by individual merchants in a manner that allows merchants to be funded virtually instantaneously for credit card batches submitted via a real-time settlement process.

### RELATED APPLICATIONS

This utility patent application claims the benefit of U.S. Provisional Patent Application Ser. No. 62/558,713, filed on Sep. 14, 2017, which is hereby incorporated by reference in its entirety.

### THE FIELD OF THE INVENTION

This invention relates to real time settlement of credit card batches, including without limitation, a system and method that enables merchants to be funded instantly for batches created and submitted in a virtual terminal.

### BACKGROUND

Merchants may be described generally as any person or entity that provides goods and/or services to customers in exchange for some amount of payment. Payments to merchants can be made in a variety of ways and generally include payment by cash from the customer to the merchant or cash-substitute payments, which may include credit card and/or debit card payments.

When a merchant swipes a customer's credit card, the merchant's credit card terminal connects to the merchant's acquirer, or credit card processor. An acquirer may be described generally as a bank, acquiring bank, sponsor bank, or any financial institution that processes credit card payments. The acquirer verifies that the customer's account is valid and that sufficient funds are available to cover the proposed transaction's cost. At this step or point of the transaction, the funds may be described as “held” and deducted from the customer's credit limit, but the funds are not yet transferred to the merchant. Similarly, if the customer is using a debit card, the acquirer verifies that the customer's account is valid and that sufficient funds are available to cover the transaction's cost, then the funds are “held” and deducted from the customer's available account balance, but are not yet transferred to the merchant.

At some time, the merchant instructs the credit card terminal or machine to submit the finalized transactions to the acquirer in what may be described as a “batch” or “batch transfer.” This batch transfer begins the settlement process where the funds are transferred from the customers' accounts to the merchant's account.

Generally, this settlement process is not instantaneous. For example, the transaction may not appear on the customer's statement or online account activity for one to two days, and it may take up to three days for the funds to be deposited into the merchant's account.

What is needed is an apparatus, system and method for funding merchants virtually instantaneously after a batch transfer is submitted, including without limitation, enabling merchants to customize their batchout threshold amount and creating an automated process for batch settlement.

### BRIEF SUMMARY OF THE INVENTION

In accordance with the foregoing, certain embodiments of a real-time settlement (hereinafter “RTS”) system may provide systems and methods for settling credit card batches in real time.

In one embodiment, a merchant service provider may provide an RTS system and/or process to an acquirer, or acquiring bank. The merchant service provider provides and maintains the hardware and/or software necessary to provide the RTS merchant service. The merchant service provider works closely with the acquirer with respect to the RTS merchant service. The acquirer is enabled to offer the RTS merchant service to merchants that are associated with or work with the acquirer.

In one embodiment, merchants may be funded virtually instantaneously for credit card batches created in a virtual terminal. An RTS system may be customized according to the needs or desires of an individual merchant.

A system may include a process for resolution for card BIN that fail the validation process. Generally, a BIN number may consist of the first 6 or 8 numbers on a debit or credit card.

In one embodiment, a method for funding merchants or processing payment card batches may comprise providing an RTS provider, wherein the RTS provider operates an RTS provider node that is operably connected to an acquirer node and that is operably connected to a merchant node and includes a virtual terminal and operates an RTS merchant service; providing an acquirer, wherein the acquirer operates the acquirer node; providing a merchant, wherein the merchant operates a payment terminal and has a merchant account linked to a merchant card and operates the merchant node; boarding the merchant, by the acquirer, onto a system that supports the RTS merchant service; verifying, by the RTS provider, that the merchant account is properly linked with the merchant card and able to receive funding via the RTS merchant service, which verification is accomplished via communications between the merchant node and the acquirer node and the RTS provider node; enabling the RTS merchant service via communications between the merchant node and the virtual terminal included with the RTS provider node; batching a batch, by the merchant via the virtual terminal; submitting the batch via communications between the merchant node through the virtual terminal and to the acquirer node; settling the batch via the RTS merchant service; and funding the merchant account within approximately ten (10) seconds after the submitting the batch.

In another embodiment, a similar process for funding a merchant or processing a payment card batch may further comprise pre-boarding the merchant, before boarding the merchant and by the acquirer, and verifying that the RTS merchant service is available to the merchant and performing at least one anti-fraud check against the merchant. Also, the batch may be comprised of multiple credit card transactions to be settled. Also, the batch processing may further comprise settling a first portion of the batch via the RTS merchant service; funding the first portion of the batch to the merchant account within approximately ten (10) seconds of the submitting the batch; settling a second portion of the batch via a traditional settlement process; and funding the second portion of the batch to the merchant account between approximately two to three (2-3) days of the submitting the batch. The first portion of the batch or the second portion of the batch may equal zero.

In another embodiment, a real-time settlement (RTS) system to process payment card batches may comprise an RTS provider node comprising an RTS processor and an RTS memory; an RTS virtual terminal comprising instructions stored in the RTS memory and executed by the RTS processor so as to be able to perform the steps of: obtaining, by the RTS virtual terminal from a merchant node, a merchant account and a batch of payment card transactions to be settled; sorting, by the RTS virtual terminal, the batch of payment card transactions into an RTS batch and an ACH batch; transmitting, by the RTS virtual terminal to an acquirer node, a first request to settle the RTS batch via RTS rails and settling the RTS batch to acquire RTS settlement funds; and funding, by the RTS virtual terminal via the acquirer node, the merchant account with the RTS settlement funds within approximately ten (10) seconds of the obtaining.

The RTS batch or the ACH batch may include numerous payment card transactions or zero payment card transactions.

In another embodiment, a real-time settlement (RTS) system for processing payment card batches may comprise a merchant node comprising a merchant processor and a merchant memory; a merchant module comprising instructions stored in the merchant memory and executed by the merchant processor so as to able to perform the steps of: identifying, by the merchant module, a merchant account and a merchant funding instrument; initiating, by the merchant module, payment card transactions; batching, by the merchant module, the payment card transactions into a batch; and communicating with an acquirer node and an RTS provider node; the acquirer node comprising an acquirer processor and an acquirer memory; an acquirer module comprising instructions stored in the acquirer memory and executed by the acquirer processor so as to be able to perform the steps of: receiving, by the acquirer module from the merchant module, merchant information including at least one of the merchant account and the merchant funding instrument; communicating with the merchant node and the RTS provider node; processing payment card settlement payments via an ACH settlement process; and funding the merchant account; the RTS provider node comprising an RTS processor and an RTS memory; an RTS virtual terminal comprising instructions stored in the RTS memory and executed by the RTS processor so as to be able to perform the steps of: processing payment card settlement payments via an RTS settlement process; comparing, by the RTS virtual terminal through the acquirer module, the merchant account and the merchant funding instrument with a BIN database; evaluating, by the RTS virtual terminal via the acquirer module, whether the merchant information will facilitate settlement payments via the RTS system; and enabling, by the RTS virtual terminal via the acquirer module, settlement and funding of the merchant account via the RTS system; obtaining, by the RTS virtual terminal from the merchant module, the merchant account and the batch of payment card transactions to be settled; sorting, by the RTS virtual terminal, the batch of payment card transactions into an RTS batch and an ACH batch; transmitting, by the RTS virtual terminal to the acquirer node, a first request to settle the RTS batch via RTS rails and settling the RTS batch to acquire RTS settlement funds; transmitting, by the RTS virtual terminal to the acquirer node, a second request to settle the ACH batch via ACH rails and settling the ACH batch to acquire ACH settlement funds; and funding, by the RTS virtual terminal through the acquirer node, the merchant account with the RTS settlement funds within approximately ten (10) seconds of the obtaining; funding, by the RTS virtual terminal through the acquirer node, the merchant account with the ACH settlement funds between approximately two to three (2-3) days of the obtaining.

Moreover, the merchant module, by the RTS virtual terminal, may further able to perform the step of batching to include batching the payment card transactions according to at least one of the date of the payment card transaction, the amount of the payment card transaction, and the type of the payment card transaction.

In another embodiment, a real-time settlement (RTS) system for processing payment card batches may comprise an RTS provider node comprising an RTS processor and an RTS memory; an RTS virtual terminal comprising instructions stored in the RTS memory and executed by the RTS processor so as to be able to perform the steps of: communicating with an acquirer node; communicating with a merchant node; receiving, by the RTS virtual terminal from the merchant node through the acquirer node, merchant information comprising a merchant account and a merchant card; evaluating, by the RTS virtual terminal through the acquirer node, whether the merchant information will support settlement of a payment card transaction via an RTS rail; enabling, by the RTS virtual terminal through the acquirer node, settlement and funding of a payment card transaction via the RTS system; obtaining, by the RTS virtual terminal from the merchant node, the merchant account and a batch of payment card transactions to be settled; sorting, by the RTS virtual terminal, the batch of payment card transactions into an RTS batch and an ACH batch; transmitting, by the RTS virtual terminal to the acquirer node, a first request to settle the RTS batch via RTS rails and settling the RTS batch to acquire RTS settlement funds; funding, by the RTS virtual terminal through the acquirer node, the merchant account with the RTS settlement funds within approximately ten (10) seconds of the obtaining; transmitting, by the RTS virtual terminal to the acquirer node, a second request to settle the ACH batch via ACH rails and settling the ACH batch to acquire ACH settlement funds; and funding, by the RTS virtual terminal via the acquirer node, the merchant account with the ACH settlement funds between approximately two to three (2-3) days of the obtaining.

The RTS virtual terminal may also be able to perform the steps of: receiving, by the RTS virtual terminal from the merchant node, the payment card transactions; and batching the payment card transactions, by the RTS virtual terminal, according to at least one of the date of the payment card transaction, the amount of the payment card transaction, and the type of the payment card transaction. The RTS virtual terminal may also be able to perform the step of comparing, by the RTS virtual terminal through the acquirer node, the merchant information against a BIN database. The RTS virtual terminal may also be able to perform the step of running at least one anti-fraud check against the merchant information.

One aspect of the present disclosure relates to a system configured for real-time settlement of a credit card batch transaction. The system may include one or more hardware processors configured by machine-readable instructions. The processor(s) may be configured to provide an RTS provider. The RTS provider may operate an RTS provider node that is operably connected to an acquirer node and that is operably connected to a merchant node and includes a virtual terminal and operates an RTS merchant service. The processor(s) may be configured to provide an acquirer. The acquirer may operate the acquirer node. The processor(s) may be configured to provide a merchant. The merchant may operate a payment terminal and has a merchant account linked to a merchant card and operates the merchant node. The processor(s) may be configured to board the merchant, by the acquirer, onto a system that supports the RTS merchant service. The processor(s) may be configured to verify, by the RTS provider, that the merchant account is properly linked with the merchant card and able to receive funding via the RTS merchant service, which verification is accomplished via communications between the merchant node and the acquirer node and the RTS provider node. The processor(s) may be configured to enable the RTS merchant service via communications between the merchant node and the virtual terminal included with the RTS provider node. The processor(s) may be configured to batch a batch, by the merchant via the virtual terminal. The processor(s) may be configured to submit the batch via communications between the merchant node through the virtual terminal and to the acquirer node. The processor(s) may be configured to settle the batch via the RTS merchant service. The processor(s) may be configured to fund the merchant account within approximately ten seconds after the submitting the batch.

Another aspect of the present disclosure relates to a method for real-time settlement of a credit card batch transaction. The method may include providing an RTS provider. The RTS provider may operate an RTS provider node that is operably connected to an acquirer node and that is operably connected to a merchant node and includes a virtual terminal and operates an RTS merchant service. The method may include providing an acquirer. The acquirer may operate the acquirer node. The method may include providing a merchant. The merchant may operate a payment terminal and has a merchant account linked to a merchant card and operates the merchant node. The method may include boarding the merchant, by the acquirer, onto a system that supports the RTS merchant service. The method may include verifying, by the RTS provider, that the merchant account is properly linked with the merchant card and able to receive funding via the RTS merchant service, which verification is accomplished via communications between the merchant node and the acquirer node and the RTS provider node. The method may include enabling the RTS merchant service via communications between the merchant node and the virtual terminal included with the RTS provider node. The method may include batching a batch, by the merchant via the virtual terminal. The method may include submitting the batch via communications between the merchant node through the virtual terminal and to the acquirer node. The method may include settling the batch via the RTS merchant service. The method may include funding the merchant account within approximately ten seconds after the submitting the batch.

Yet another aspect of the present disclosure relates to a non-transient computer-readable storage medium having instructions embodied thereon, the instructions being executable by one or more processors to perform a method for real-time settlement of a credit card batch transaction. The method may include providing an RTS provider. The RTS provider may operate an RTS provider node that is operably connected to an acquirer node and that is operably connected to a merchant node and includes a virtual terminal and operates an RTS merchant service. The method may include providing an acquirer. The acquirer may operate the acquirer node. The method may include providing a merchant. The merchant may operate a payment terminal and has a merchant account linked to a merchant card and operates the merchant node. The method may include boarding the merchant, by the acquirer, onto a system that supports the RTS merchant service. The method may include verifying, by the RTS provider, that the merchant account is properly linked with the merchant card and able to receive funding via the RTS merchant service, which verification is accomplished via communications between the merchant node and the acquirer node and the RTS provider node. The method may include enabling the RTS merchant service via communications between the merchant node and the virtual terminal included with the RTS provider node. The method may include batching a batch, by the merchant via the virtual terminal. The method may include submitting the batch via communications between the merchant node through the virtual terminal and to the acquirer node. The method may include settling the batch via the RTS merchant service. The method may include funding the merchant account within approximately ten seconds after the submitting the batch.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

The foregoing features of the present invention will become more fully apparent from the following description and appended claims, taken in conjunction with the accompanying drawings. Understanding that these drawings depict only typical embodiments of the invention are, therefore, not to be considered limiting of its scope, the invention will be described with additional specificity and detail through use of the accompanying drawings in which:

FIG. 1 is a schematic block diagram of a hardware suite hosting a system and executing the software in accordance with the invention as described herein;

FIG. 2 is a schematic block diagram of a system of computers interacting with one another in order to implement one embodiment of an apparatus and method in accordance with the invention;

FIG. 3 is a flow diagram illustrating a process for pre-boarding verification in accordance with exemplary embodiments;

FIG. 4 is a flow diagram illustrating a process for merchant boarding in accordance with exemplary embodiments;

FIG. 5 is a flow diagram illustrating a process for enabling RTS in accordance with exemplary embodiments;

FIG. 6 is a flow diagram illustrating a process for settling a cred card batch, including possible processing a batch using RTS in accordance with exemplary embodiments;

FIG. 7 illustrates a system configured for real-time settlement of a credit card batch transaction, in accordance with one or more implementations; and

FIG. 8 illustrates a method for real-time settlement of a credit card batch transactions, in accordance with one or more implementations.

### DETAILED DESCRIPTION OF THE PREFERRED EMBODIMENTS

It will be readily understood that the components of the present invention, as generally described and illustrated in the drawings herein, could be arranged and designed in a wide variety of different configurations, systems or methods. Thus, the following more detailed description of the embodiments of the systems and methods of use of the present invention, as represented in the drawings, is not intended to limit the scope of the invention, as claimed, but is merely representative of various embodiments of the invention. The illustrated embodiments of the invention will be best understood by reference to the drawings, wherein like parts are designated with like numerals throughout.

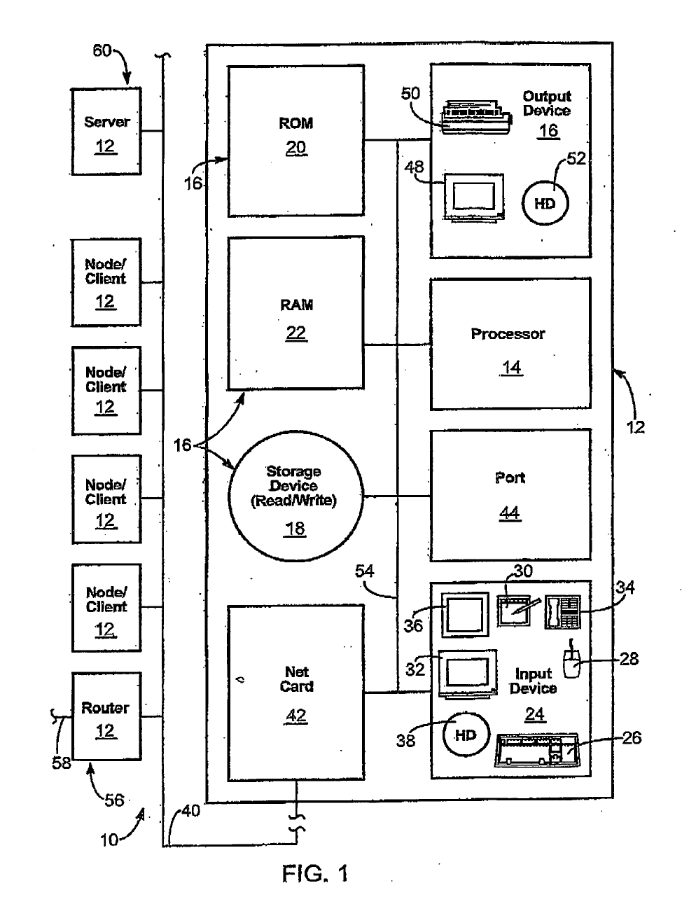

Referring to FIG. 1, an apparatus 10 or system 10 for implementing the present invention may include one or more nodes 12 (e.g., client 12, computer 12). Such nodes 12 may contain a processor 14 or CPU 14. The CPU 14 may be operably connected to a memory device 16. A memory device 16 may include one or more devices such as a hard drive 18 or other non-volatile storage device 18, a read-only memory 20 (ROM 20), and a random access (and usually volatile) memory 22 (RAM 22 or operational memory 22). Such components 14, 16, 18, 20, 22 may exist in a single node 12 or may exist in multiple nodes 12 remote from one another.

In selected embodiments, the apparatus 10 may include an input device 24 for receiving inputs from a user or from another device. Input devices 24 may include one or more physical embodiments. For example, a keyboard 26 may be used for interaction with the user, as may a mouse 28 or stylus pad 30. A touch screen 32, a telephone 34, or simply a telecommunications line 34, may be used for communication with other devices, with a user, or the like. Similarly, a scanner 36 may be used to receive graphical inputs, which may or may not be translated to other formats. A hard drive 38 or other memory device 38 may be used as an input device whether resident within the particular node 12 or some other node 12 connected by a network 40. In selected embodiments, a network card 42 (interface card) or port 44 may be provided within a node 12 to facilitate communication through such a network 40.

In certain embodiments, an output device 46 may be provided within a node 12, or accessible within the apparatus 10. Output devices 46 may include one or more physical hardware units. For example, in general, a port 44 may be used to accept inputs into and send outputs from the node 12. Nevertheless, a monitor 48 may provide outputs to a user for feedback during a process, or for assisting two-way communication between the processor 14 and a user. A printer 50, a hard drive 52, or other device may be used for outputting information as output devices 46.

Internally, a bus 54, or plurality of buses 54, may operably interconnect the processor 14, memory devices 16, input devices 24, output devices 46, network card 42, and port 44. The bus 54 may be thought of as a data carrier. As such, the bus 54 may be embodied in numerous configurations. Wire, fiber optic line, wireless electromagnetic communications by visible light, infrared, and radio frequencies may likewise be implemented as appropriate for the bus 54 and the network 40.

In general, a network 40 to which a node 12 connects may, in turn, be connected through a router 56 to another network 58. In general, nodes 12 may be on the same network 40, adjoining networks (i.e., network 40 and neighboring network 58), or may be separated by multiple routers 56 and multiple networks as individual nodes 12 on an internetwork. The individual nodes 12, or computers 12, may have various communication capabilities. In certain embodiments, a minimum of logical capability may be available in any node 12. For example, each node 12 may contain a processor 14 with more or less of the other components described hereinabove.

A network 40 may include one or more servers 60. Servers 60 may be used to manage, store, communicate, transfer, access, update, and the like, any practical number of files, databases, or the like for other nodes 12 on a network 40. Typically, a server 60 may be accessed by all nodes 12 on a network 40. Nevertheless, other special functions, including communications, applications, directory services, and the like, may be implemented by an individual server 60 or multiple servers 60.

In general, a node 12 may need to communicate over a network 40 with a server 60, a router 56, or other nodes 12. Similarly, a node 12 may need to communicate over another neighboring network 58 in an internetwork connection with some remote node 12. Likewise, individual components may need to communicate data with one another. A communication link may exist, in general, between any pair of devices.

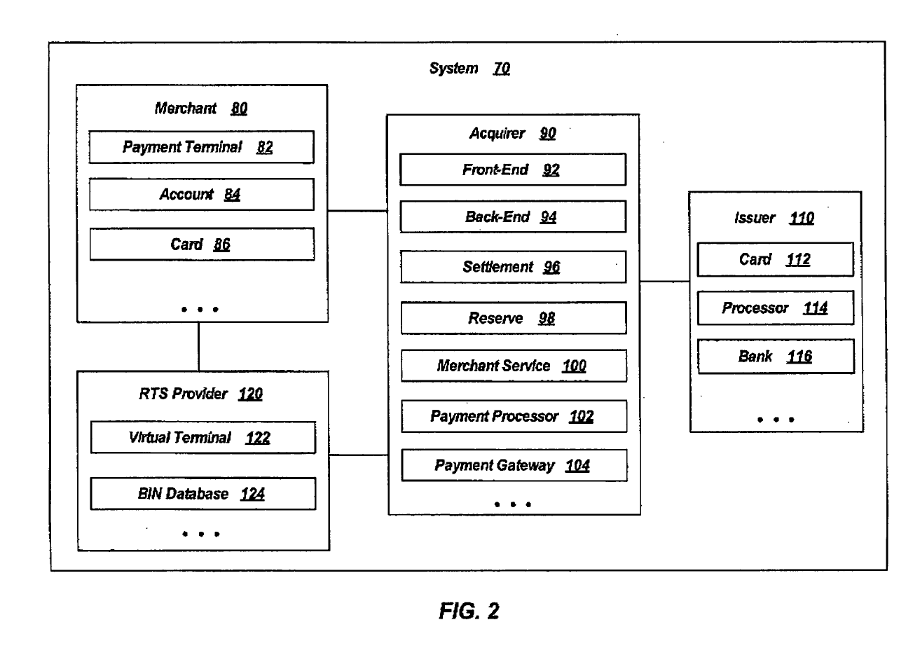

Referring to FIG. 2, a system 70 in accordance with certain embodiments of an apparatus and method corresponding to the invention may include several nodes 12, or computers 12, corresponding to various entities as identified. For example, a merchant 80 can communicate with an acquirer 90.

A merchant 80 may be described generally as any person or entity that provides goods and/or services to customers in exchange for some amount of payment. Merchants 80 may include any person or entity that trades in commodities produced by others and/or commodities they produce themselves. Merchants 80 may also be described in terms of wholesale or retail businesses.

Merchants 80 may utilize a number of tools and/or services to assist the management or function of their business. For example, a merchant 80 may utilize a payment terminal 82, or point of sale terminal, or credit card terminal. A payment terminal 82 may be described generally as a device that interfaces with various payment cards to make electronic funds transfers. A merchant 80 may also utilize a merchant account 84, which may be any bank account or financial account maintained for the merchant 80. A merchant 80 may also utilize a merchant card 86, or a settlement instrument 86, which may be any payment card that enables the merchant 80 to access its merchant account 84. Together, a merchant account 84 and a merchant card 86 may be described as a payment system for the merchant 80. There may be other tools and/or services a merchant 80 utilizes in the course of operating and maintaining its business, i.e., a merchant node 12 that comprises any necessary hardware and/or software required to communicate with other nodes 12 and operate and utilize an RTS merchant service. Use of the term “merchant” 80 herein may refer to both the merchant as an entity, and the physical merchant's business, such as locations, equipment, hardware and software comprising the merchant 80 and its business.

An acquirer 90, or acquiring bank 90, may be described as any bank or financial institution that processes credit or debit card payments on behalf of a merchant 80. An acquirer 90 may enable a merchant 80 to accept payment card payments from card-issuing banks within an association, or card association 112. An acquirer 90 may enter into a contract with a merchant 80 and offer the merchant a merchant account 84. Under the contract, an acquirer 90 may exchange funds with an issuer 110, or issuing bank 116, on behalf of the merchant 80 and then pay the merchant 80 for the merchant's payment card transactions.

An acquirer 90 may include or utilize various tools and/or services in assisting a merchant 80, i.e., an acquirer node 12 that comprises any necessary hardware and/or software required to communicate with other nodes 12 and operate and maintain an RTS merchant service. For example, an acquirer 90 may utilize a settlement account 96, or a card receipt settlement account 96, and/or a reserve account 98, or partner reserve account 98. An acquirer's settlement account 96 and/or reserve account 98 may be located at a separate, sponsor bank 105, or financial institution 105. Any number of suitable, appropriate accounts or procedures may be utilized by an acquirer 90.

An acquirer 90 may offer a merchant 80 a variety of merchant services 100. For example, such merchant services 100 may include a payment processor 102 and/or a payment gateway 104. A payment processor 102 may be a service provided to a merchant 80 by an acquirer 90 or it may be a service provided by a third-party. A payment processor 102 may be described as a company appointed by a merchant 80 to handle transactions from payment cards for acquiring banks 90. A payment processor 102 is usually broken down into two types: a front-end processor 92 and a back-end processor 94. A front-end processor 92 may be described as having connections to various card associations 112 and supplying authorization and settlement services to merchants 80. A back-end processor 94 may be described as accepting settlements from front-end processors 92 and transferring money from an issuing bank 116 to an acquirer 90, so the acquirer 90 can transfer the money to the merchant's account 84. A payment gateway 104 may be a service provided to a merchant 80 by an acquirer 90 or it may be a service provided by a third-party. A payment gateway 104 may be described as authorizing credit card payment or direct payment processing for e-businesses or online retailers, or the like. A payment gateway 104 may be described as facilitating a payment transaction by transferring information between a payment portal (i.e., a website, mobile phone, or the like) and a front-end processor 92 or acquirer 90. Use of the term “acquirer” 90 herein may refer to both the acquirer as an entity, and the physical acquirer's business, such as locations, equipment, hardware and software comprising the acquirer 90 and its business.

An issuer 110 may be described as any legal entity, or multiple legal entities, that registers and sells securities for the purpose of financing. An issuer 110 may be described as a card association 112, an issuer processor 114, and/or an issuing bank 116. Generally, a card association 112 may be described as a network of issuing banks 116 and acquirers 90 that process payment cards, usually of a specific brand. Generally, an issuing bank 116 may be described as a bank that offers payment cards branded by a card association directly to consumers. An issuer 110 may include or utilize various tools and/or services in performing relevant financial transactions, i.e., an issuer node 12 that comprises any necessary hardware and/or software required to communicate with other nodes 12 and operate and perform various financial transactions. Generally, an issuer 110 is used for processing or settling a cred card batch via the traditional means. Use of the term “issuer” 110 herein may refer to both the issuer as an entity, and the physical issuer's business, such as locations, equipment, hardware and software comprising the issuer 110 and its business.

A provider 120, or RTS provider 120, may be described as any entity or merchant service provider that enables or facilitates an RTS merchant service. A provider 120 may include or utilize various tools and/or services in enabling an acquirer 90 to provide an RTS merchant service to a merchant 80. For example, a provider 120 may utilize a virtual terminal 122, a BIN (Bank Identification Number) database 124, and/or any other hardware and software necessary to provide an RTS merchant service, i.e., an RTS provider node 12 that comprises any necessary hardware and/or software required to communicate with other nodes 12 and operate and maintain an RTS merchant service. Use of the term “provider” or “RTS provider” 120 herein may refer to both the provider as an entity, and the physical provider's business, such as locations, equipment, hardware and software comprising the provider 120 and its business.

A virtual terminal 122 may be described as an interface between an acquirer 90 and a merchant 80 that facilitates the RTS merchant service. A virtual terminal 122 may include any hardware and/or software necessary to perform and verify the financial transactions required to provide the RTS merchant service. A virtual terminal 122 may be designed to work with any merchant payment terminal 82. A virtual terminal 122 may be designed to allow the merchant 80 to make or adjust various settings associated with the RTS merchant service, for example, setting a threshold amount for a batch, updating a merchant card 86, and the like.

However, a provider 120 may engineer a solution that works with any merchant payment terminal 82 and is not dependent upon a virtual terminal 122. A provider 120 may engineer a solution that may be designed to allow the merchant 80 to make or adjust various settings associated with the RTS merchant service, for example, setting a threshold amount for a batch, verify that a merchant card 86 is properly linked to a merchant account 84, update a merchant card 86, and the like.

A BIN database 124 may be described as a database or list identifying available banks that may be able to facilitate or provide an RTS merchant service. A BIN database 124 may also be used to distinguish between which banks have been verified as able to facilitate an RTS merchant service and which have not been so verified.

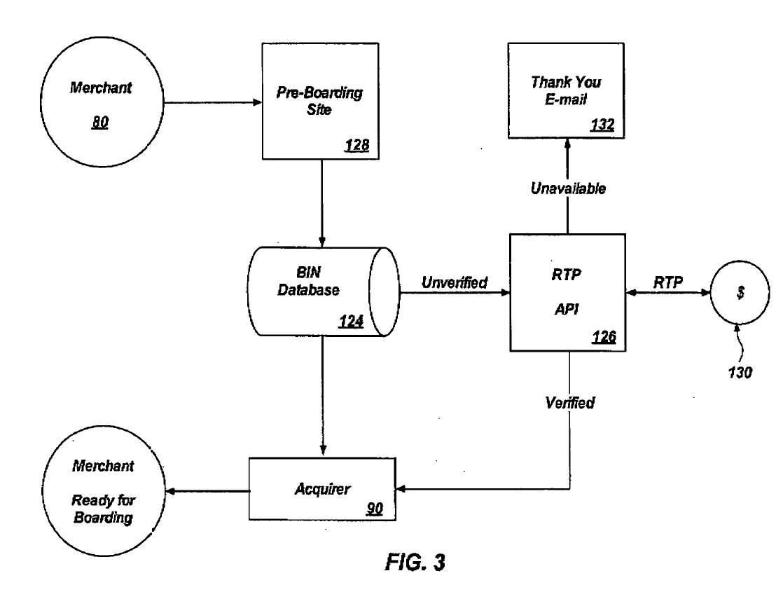

Referring to FIG. 3, in one embodiment, there is a process whereby a merchant 80 intending to utilize an RTS merchant service may be required to undergo a pre-boarding verification, or a pre-approval process. A pre-boarding verification may be used to verify that a merchant card 86 will successfully process on RTS rails. In a preferred embodiment, a provider 120 may provide an acquirer 90 the tools and/or information to perform a pre-boarding verification by, for example, checking a bank against the provider's BIN database 124, and sending a test transaction for banks that are not verified via the BIN database 124.

In one embodiment, the steps for performing a pre-boarding verification may include verifying a merchant card 86 and verifying that the merchant card 86 will successfully process on RTS rails. A merchant 80 may access a pre-boarding site 128. A pre-boarding site 128 may be supplied by an acquirer 90, whereby the acquirer 90 facilitates the pre-boarding verification performed by a provider 120. A pre-boarding site 128 may include any hardware and/or software necessary to perform a pre-boarding verification.

The merchant 80 enters information regarding the merchant card 86 via the pre-boarding site 128, including at least the BIN number of the merchant card 86. The acquirer 90 may then compare or verify the BIN number of the merchant card 86 against the BIN database 124. If the BIN number of the merchant card 86 is not found on or verified by the comparison with the BIN database 124, the acquirer 90 may use the pre-boarding site 128 to relay a message to the merchant 80 and request that the merchant 80 enter a new merchant card 86 with a new, separate BIN number. Then this step can be repeated. If the BIN number of the merchant card 86 is found in the comparison with the BIN database 124, the BIN number may then be verified to ensure that it will successfully process on RTS rails.

Once the BIN number of a merchant card 86 is confirmed as available by the BIN database 124, the BIN database 124 may also determine whether the merchant card 86 will successfully process on RTS rails. If the merchant card 86 is verified as being able to process on RTS rails, that verification may be communicated to the acquirer 90. The acquirer 90 may then notify 134 the merchant 80 that the merchant 80 is ready for boarding, or for setting up the RTS merchant service.

If the merchant card 86 is initially un-verified as being able to process on RTS rails, a test may be performed to determine whether the merchant card 86 may process on RTS rails. A provider 120 may utilize appropriate an API (Application Programs Interface) to send or run an RTP (Request to Pay) 126 relative to the merchant card 86. For example, an RTP 126 could be run to the merchant card 86 wherein a nominal amount of money 130 is payed to the merchant card 86 utilizing RTS rails. If the money 130 is successfully paid to the merchant card 86, the BIN number of that merchant card 86 is verified, or marked, as being able to successfully process on RTS rails and the acquirer 90 is notified of this verification. The acquirer 90 may also be allowed to capture the last 4 digits of the merchant card 86 upon BIN number verification. The acquirer 90 may then notify 134 the merchant 80 that the merchant 80 is ready for boarding, or for setting up the RTS merchant service. If the money 130 is not successfully paid to the merchant card 86, the BIN number of that merchant card 86 is not verified and may be marked as being unable to successfully process on RTS rails and a message 132 may be sent to the acquirer 90 and/or the merchant 80 notifying them that the RTS merchant service is unavailable under the current circumstances.

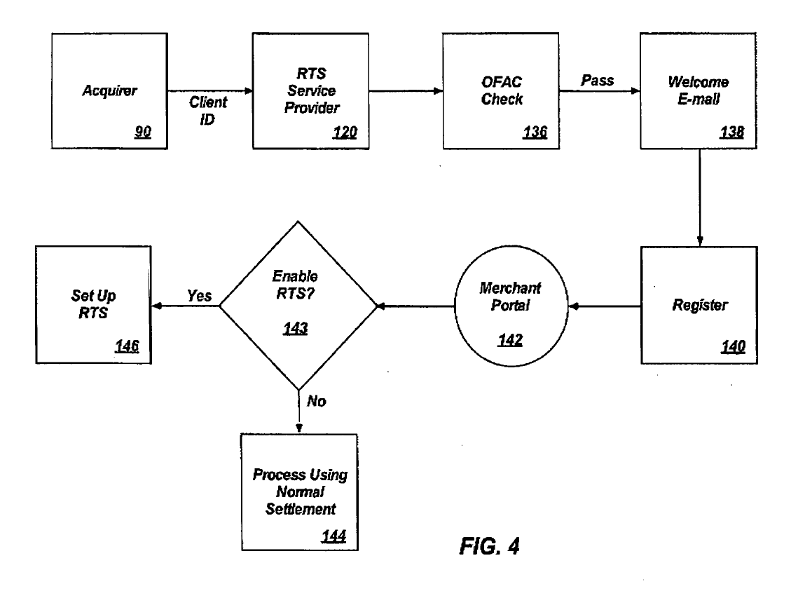

Referring to FIG. 4, in one embodiment, there is a process whereby an acquirer 90 offering and providing an RTS merchant service may work with a provider 120 to provide a merchant 80 the RTS merchant service. Before a merchant 80 can utilize an RTS merchant service, the merchant 80 must go through a boarding process, or registration process, with the merchant's acquirer 90, which acquirer 90 is providing the RTS merchant service to the merchant 80. The acquirer 90 may then “board” the merchant 80 onto a provider's 120 RTS merchant service. The provider's 120 RTS merchant service may include any hardware and/or software required for the provider 120 to operate and maintain the RTS merchant service.

The acquirer 90 obtains certain information, or merchant identification information, from the merchant 80. The merchant identification information required for registration of a merchant 80 may include the following: a legal business name; a DBA (doing business as); a business address; a business telephone number; a federal tax identification number; an MCC code (Merchant Category Code); a website or web URL; a principal's name; a principal's date of birth; a principal's social security number; a principal's driver's license number; a principal's driver's license state; a principal's driver's license issue date; a principal's driver's license expiration date; a principal's telephone number; a principal's e-mail address; a merchant account 84 number; a route, or routing number; gateway credentials; an RTP item limit (i.e., max $10,000); and the last four (4) digits of the merchant card 86. Once acquirer 90 sends the merchant identification information to the provider 120, the provider 120 may notify acquirer 90 whether the merchant identification information is acceptable. Provider 120 may send a message to acquirer 90 that an information failure has occurred and provide a suitable error response code. Provider 120 may send a message to acquirer 90 that the merchant identification information is acceptable and provider 120 is proceeding with the merchant 80 boarding process.

Provider 120 may use the merchant identification information to evaluate the merchant 80, including by running a variety of anti-fraud measures. For example, and not by way of limitation, a provider 120 may compare the merchant identification information against an OFAC (Office of Foreign Assets Control) watchlist 136. If the merchant 80 or any merchant identification information matches information found on the OFAC watchlist 136, the provider 120 may notify the acquirer 90 that the boarding process has failed and merchant 80 may not be allowed to use the RTS merchant service. The provider 120 or acquirer 90 may or may not notify merchant 80 regarding the outcome or specifics regarding the results of the anti-fraud testing. If the merchant 80 or any merchant identification information does not match information found on the OFAC watchlist 136, the provider 120 may notify the acquirer 90 that the merchant 80 has passed the boarding process and use of the RTS merchant service may proceed.

The acquirer 90 may send the merchant 80 notification 138, or a welcome e-mail 138, using the acquirer's branding to notify the merchant 80 that the merchant 80 may proceed to utilize the RTS merchant service. The notification 138 may contain various information 140 and/or directions to register 140 before using the RTS merchant service. For example, the notification 138 may include a link to verify any e-mail address provided. The notification 138, or a link, may also direct the merchant 80 to create a username and password for use with the RTS merchant service. The notification 138 may also require the merchant 80 to agree to any of acquirer's 90 terms and conditions. Once the boarding process is completed to the satisfaction of the provider 120 and/or the acquirer 90, the merchant 80 is granted access to a merchant portal 142, which merchant portal 142 may be branded by the acquirer 90.

Through the merchant portal 142, the merchant 80 may be instructed on how to set up 146 the RTS merchant service. For example, the merchant portal 142 may include a dashboard notification that is displayed inside the merchant portal 142. The acquirer 90 may send the merchant 80 an e-mail containing details, information and/or links on how to enable 143 and set up 146 the RTS merchant service.

The merchant 80 may refuse to enable 143 the RTS merchant service. If the merchant 80 refuses to enable 143 the RTS merchant service, the acquirer 90 will use a traditional settlement process 144 for the merchant's 80 batches and related financial transactions. The merchant 80 may still utilize the virtual terminal 122 as normal.

If the merchant 80 enables 143 the RTS merchant service, the merchant 80 will proceed to set up 146 the RTS merchant service and the acquirer 90 will process merchant's 80 batches and related financial transactions accordingly.

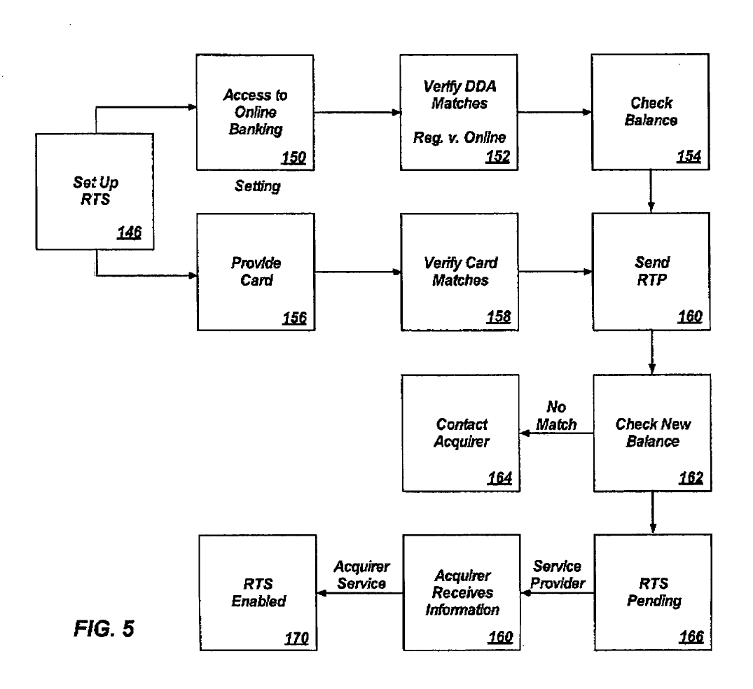

Referring to FIG. 5, in one embodiment, there are one or more processes whereby a merchant 80 may set up 146 an RTS merchant service. The merchant 80 may be described as having access into the merchant portal 142. The set up 146 process may be facilitated or completed by allowing the merchant 80 to use a settings page 150, or by allowing access to online banking information. A settings page 150 may be provided as part of and/or within the merchant portal 142. Information to be provided by the merchant 80 in the settings page 150 may include the following: a business debit card number, or merchant card 86, which must match the last four (4) digits of the pre-verified merchant card 86; a business debt card expiration date, or merchant card 86 expiration date; an online banking username; an online banking password; and a batchout limit amount (i.e., <$10,000.00).

Once the required information is provided by the merchant 80 in the settings page 150, and once that information is saved within the system, a provider 120 may compare the DDAs (Demand Deposit Accounts) 152. In comparing the DDAs 152, the provider 120 may compare or evaluate the online banking information provided by the merchant 80 during set up 146 with the merchant identification information previously provided to the acquirer 90 when the merchant 80 went through the boarding process. The provider 120 may then verify the current DDA balance 154.

The set up process 146 may also be facilitated or completed by allowing the merchant to provide 156 a merchant card 86. Once the merchant card information is provided 156 by the merchant 80, and once that information is saved within the system, a provider 120 may compare and verify 158 the merchant card. In verifying the card 158, the provider 120 may compare or evaluate the merchant card 86 provided by the merchant 80 during set up 146 with the merchant identification information previously provided to the acquirer 90 when the merchant 80 went through the boarding process.

The provider 120 may then send an RTP 160 transaction to “ping” the business debit card, or merchant card 86, for example, by sending a RTP for a nominal amount (i.e., >$1.00). The provider 120 may then re-verify the DDA balance 162, which should now include the RTP 160 “ping” amount. If this verification is not performed successfully, the provider 120 may notify the acquirer 90 that the RTP 160 “ping” amount was not received in the DDA balance as expected 164. If this verification is performed successfully, the provider 120 may notify the acquirer 90 accordingly and an RTS to the merchant 80 may be considered pending 166. Put another way, the provider 120 may notify the acquirer 90 that the merchant 80 has successfully set up the RTS merchant service.

Upon successful RTS set up, and an RTS may be considered pending 166, the provider 120 may send the acquirer 90 a push response 168 indicating that the merchant 80 has enabled the RTS merchant service. This push response 168 to the acquirer 90 may include information regarding a merchant sub-account number, or merchant account 84, for omnibus settlement.

Once the acquirer 90 has been notified by the provider 120 that the merchant 80 has successfully set up the RTS merchant service, the acquirer 90 may complete setting up merchant settlement 170, or enable the RTS merchant service 170. The acquirer 90 may set up the merchant 80 for next day funding. The acquirer 90 may edit settlement to fund sponsor bank omnibus account, or merchant account 84. The acquirer 90 may include a sub-account number or a merchant account 84 in an ACH (Automated Clearing House) settlement transaction. The acquirer 90 may send the provider 120 a push response that enablement of the RTS merchant service is complete 170.

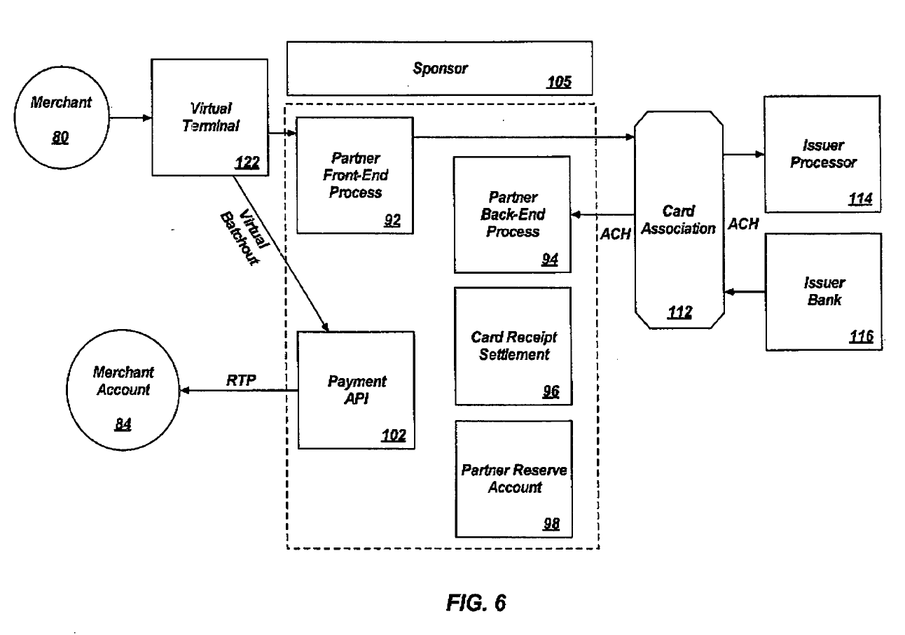

Referring to FIG. 6, one embodiment of a processing flow for an RTS merchant service is shown. A merchant 80 may be funded by one of two separate processing pathways, via RTS or ACH. For example, a merchant 80 may use a virtual terminal 122 to enable the RTS merchant service and submit batches accordingly. The virtual terminal 122 may communicate to a payment processor 102 and the payment processor 102 may initiate an RTP to the previously verified merchant account 84. Accordingly, a merchant 80 that has previously enabled 170 the RTS merchant service may receive funding for a batch within minutes or even seconds of the batch submission. Also, a merchant 80 that has not properly enabled the RTS merchant service may still be funded via a traditional ACH process, i.e., from an issuer process 114 and/or issuer bank 116.

Generally, a merchant 80 may use its payment terminal 82 and/or a virtual terminal 122 to set up the RTS merchant service. A merchant 80 may utilize a node 12 or processor 14 within its payment terminal 82, or a node 12 or processor 14 within a virtual terminal 122 to communicate with an acquirer's 90 node 12 or processor 14.

An acquirer 90 may be comprised of various components, including appropriate hardware and/or software. Such components may include a front-end processor 92, a back-end processor 94, a card receipt settlement account 96, a reserve account 98, a merchant service 100, a payment processor 102, and/or a payment gateway 104.

An acquirer's 90 node 12 or processor 14 may communicate with a card association's 112 node 12 or processor 14. The card association's 112 node 12 or processor 14 may communicate with an issuer processor's 114 node 12 or processor 14. Financial transactions between a card association 112 and an issuer processor 114 may be facilitated and/or performed by an ACH. The card association's 112 node 12 or processor 14 may communicate with an issuer bank's 116 node 12 or processor 14. Financial transactions between a card association 112 and an issuer bank 116 may be facilitated and/or performed by an ACH.

An acquirer's 90 node 12 or processor 14 may communication with a merchant's 80 node 12 or processor 14. Similarly, an acquirer 90 may use a payment processor 102 to fund, or to RTP funds, into a merchant account 84. A payment processor's 102 node 12 or processor 14 may communicate with a merchant's 80 node 12 or processor 14.

These communications and the associated systems, hardware and software may be used to facilitate and perform the RTS merchant service. The RTS merchant service may be designed and operated in a manner that allows the merchant 80 to be funded, or to reach settlement, for payment batches within a significantly shorter time than traditional settlement practices. For example, a merchant 80 may be funded by the RTS merchant service within approximately 5 minutes of batch submission, or even shorter times. A merchant 80 may still be funded by a next day ACH processed payment within approximately 24 hours of batch submission.

Moreover, exceptions may be handled within the RTS merchant service in a manner that does not disrupt processing. The system 70 may still automatically fund the merchant 80 via next day ACH.

In one embodiment, a settlement instrument, or business debit card, or merchant card 86, may need to be updated from time to time. A merchant card 86 may expire, be reported lost or stolen, or be disabled. The virtual terminal 122 may allow a merchant 80 to update its merchant card 86 directly in the settings 150. The provider 120 may run similar checks that are used to enable 170 the RTS merchant service to verify that the merchant card 86 matches the merchant account 84 on file.

A merchant 80 may utilize the settings page 150 to input a new debit card, or new merchant card 86. The provider 120 may run a verification to validate 158 that the new merchant card 86 matches DDA on file. If this verification is successful, then the new funding instrument, or new merchant card 86, is enabled. If this verification fails, then a message may be displayed that the merchant 80 needs to input a new card, or new funding instrument.

In the event of an RTS exception, a merchant 80 may still be funded via next day ACH for the exception batch. A merchant 80 may be notified via e-mail, or another suitable notification, and in reporting that items have been funded via ACH as opposed to the RTS merchant service.

If an RTS is unsuccessful in a batchout settlement transaction, the acquirer 90 may notify the merchant 80 via e-mail regarding the status of the batch. The batch or items that cannot be funded via the RTS merchant service may be moved to the normal ACH settlement process. The batch may still be funded via next day ACH and the affected batch or card transactions may be marked as “ACH Settled,” or some other appropriate descriptor.

If an RTS exception is ongoing, or after five (5) failed attempts to settle a batch, the RTS merchant service may be disabled. The acquirer 90 may send a notification to the merchant 80 via e-mail notifying the merchant 80 of the failure and requesting action to correct the issue, i.e., request that a new debit card or merchant card 86 be entered. The acquirer 90 may provide the merchant 80 a window of opportunity to update the merchant card 86, i.e., ten (10) days. If the merchant 80 does not update the merchant card 86 within the allotted ten (10) days, the acquirer 90 or the provider 120 may disable the RTS merchant service via the virtual terminal 122. The provider 120 may notify the acquirer 90 of the disabled RTS merchant service via web service or an e-mail. The acquirer 90 may then move the merchant 80 to normal settlement and funding practices.

Along with normal transactional reporting, a virtual terminal 122 may also provide additional details regarding the RTS merchant service. For example, as items are batched and settled, the virtual terminal 122 may indicate which transactions have been settled as opposed to which transactions are pending.

In addition to the normal, robust reporting provided regarding the merchant's 80 batching and funding, other reporting items may be included as a result of the activation or enablement of the RTS merchant service. For example, the RTS merchant service status may be reported, including details regarding a pending settlement (i.e., awaiting a threshold to be met), settlement and batchout completed via the RTS merchant service, and settlement and batch processed via ACH because of a settlement exception. Information related to a batch identification and a settlement timestamp may also be included.

The acquirer 90 may have a monthly statement that includes a summary broken down by merchant 80 indicating the number of settlements for the previous month. An acquirer's 90 monthly statement may include a variety of information and break downs of that information. For example, a monthly statement may include a merchant 80 list summary that includes a client identification number, a legal name, a number of batches, and a number of exception batches. A monthly statement may also include a batch list summary that includes a batch identification number, a dollar volume, a number of transactions, and batch type indicator (i.e., processed by RTS or ACH).

Any processing fees for the RTS merchant service may be taken in real time at the time of the transaction. Therefore, each batch paid or funded to the merchant 80 will incur a fee for settlement. The acquirer 90 is required to have a fee settlement account 96 located at the sponsor bank 105 with a retaining reserve amount on file. As fees are deducted from this reserve, it will auto-replenish based on the percent remaining. The acquirer 90 will be provided details on the fees to pass along this fee to the acquirer's 90 merchant 80.

In another embodiment, a system allows a merchant to utilize a real-time settlement merchant service to receive funding for a batch of payment card transactions.

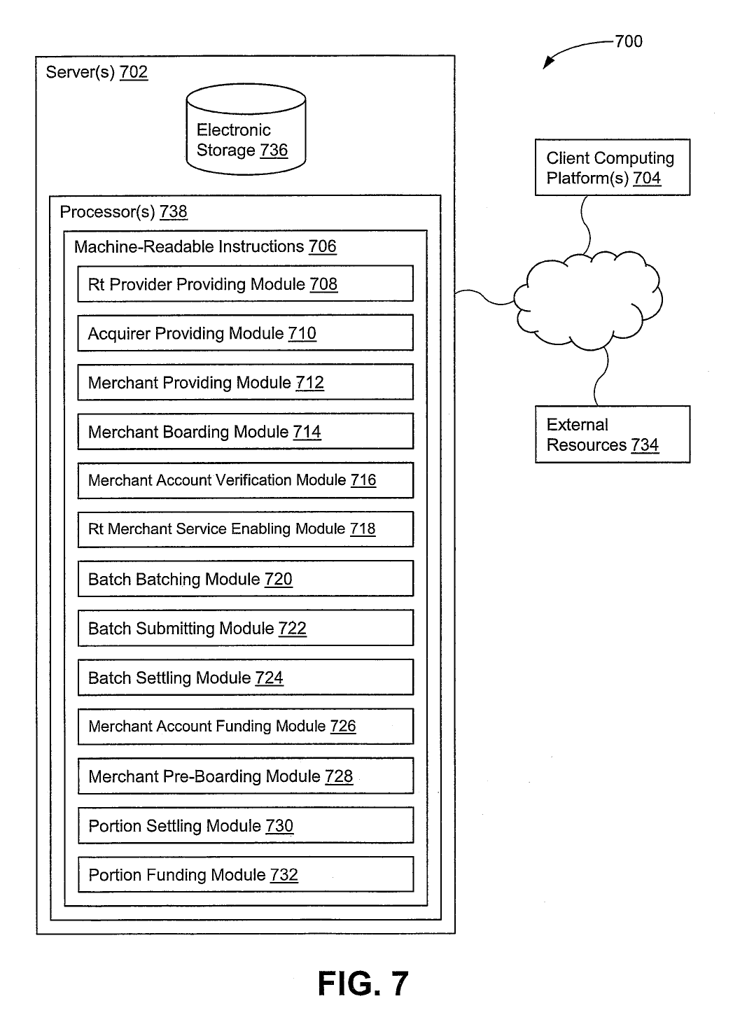

FIG. 7 illustrates a system 700 configured for real-time settlement of a credit card batch transaction, in accordance with one or more implementations. In some implementations, system 700 may include one or more servers 702. Server(s) 702 may be configured to communicate with one or more client computing platforms 704 according to a client/server architecture and/or other architectures. Client computing platform(s) 704 may be configured to communicate with other client computing platforms via server(s) 702 and/or according to a peer-to-peer architecture and/or other architectures. Users may access system 700 via client computing platform(s) 704.

Server(s) 702 may be configured by machine-readable instructions 706. Machine-readable instructions 706 may include one or more instruction modules. The instruction modules may include computer program modules. The instruction modules may include one or more of a rt provider providing module 708, an acquirer providing module 710, a merchant providing module 712, a merchant boarding module 714, a merchant account verification module 716, art merchant service enabling module 718, a batch batching module 720, a batch submitting module 722, a batch settling module 724, a merchant account funding module 726, a merchant pre-boarding module 728, a portion settling module 730, a portion funding module 732, and/or other instruction modules.

Rt provider providing module 708 may be configured to provide, or operably connect to, an RTS provider. The RTS provider may operate an RTS provider node that is operably connected to an acquirer node and that is operably connected to a merchant node and includes a virtual terminal and operates an RTS merchant service.

Acquirer providing module 710 may be configured to provide, or operably connect to, an acquirer. The acquirer may work with a sponsor bank to facilitate the settling process. The acquirer may operate the acquirer node.

Merchant providing module 712 may be configured to provide, or operably connect to, a merchant. The merchant may operate a payment terminal and has a merchant account linked to a merchant card and operates the merchant node.

Merchant boarding module 714 may be configured to board the merchant, by the acquirer, onto a system that supports the RTS merchant service.

Merchant account verification module 716 may be configured to verify, by the RTS provider, that the merchant account is properly linked with the merchant card and able to receive funding via the RTS merchant service, which verification is accomplished via communications between the merchant node and the acquirer node and the RTS provider node.

Rt merchant service enabling module 718 may be configured to enable the RTS merchant service via communications between the merchant node and the virtual terminal included with the RTS provider node.

Batch batching module 720 may be configured to batch a payment card batch, by the merchant via the virtual terminal. The payment card batch may be included of multiple credit card transactions to be settled.

Batch submitting module 722 may be configured to submit the payment card batch via communications between the merchant node through the virtual terminal and to the acquirer node.

Batch settling module 724 may be configured to settle the payment card batch via the RTS merchant service.

Merchant account funding module 726 may be configured to fund the merchant account within approximately ten seconds after the submitting the payment card batch.

Merchant pre-boarding module 728 may be configured to pre-board the merchant, before boarding the merchant and by the acquirer, and verifying that the RTS merchant service is available to the merchant and performing at least one anti-fraud check against the merchant.

Portion settling module 730 may be configured to settle a first portion of the payment card batch via the RTS merchant service.

Portion settling module 730 may be configured to settle a second portion of the payment card batch via a traditional settlement process. A traditional settlement process may include use of an ACH, or similar financial institution.

Portion funding module 732 may be configured to fund the first portion of the payment card batch to the merchant account within approximately ten seconds of the submitting the payment card batch.

Portion funding module 732 may be configured to fund the second portion of the payment card batch to the merchant account between approximately two to three days of the submitting the payment card batch.

In some implementations, server(s) 702, client computing platform(s) 704, and/or external resources 734 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which server(s) 702, client computing platform(s) 704, and/or external resources 734 may be operatively linked via some other communication media.

A given client computing platform 704 may include one or more processors configured to execute computer program modules. The computer program modules may be configured to enable an expert or user associated with the given client computing platform 704 to interface with system 700 and/or external resources 734, and/or provide other functionality attributed herein to client computing platform(s) 704. By way of non-limiting example, the given client computing platform 704 may include one or more of a desktop computer, a laptop computer, a handheld computer, a tablet computing platform, a NetBook, a Smartphone, a gaming console, and/or other computing platforms.

External resources 734 may include sources of information outside of system 700, external entities participating with system 700, and/or other resources. In some implementations, some or all of the functionality attributed herein to external resources 734 may be provided by resources included in system 700.

Server(s) 702 may include electronic storage 736, one or more processors 738, and/or other components. Server(s) 702 may include communication lines, or ports to enable the exchange of information with a network and/or other computing platforms. Illustration of server(s) 702 in FIG. 7 is not intended to be limiting. Server(s) 702 may include a plurality of hardware, software, and/or firmware components operating together to provide the functionality attributed herein to server(s) 702. For example, server(s) 702 may be implemented by a cloud of computing platforms operating together as server(s) 702.

Electronic storage 736 may comprise non-transitory storage media that electronically stores information. The electronic storage media of electronic storage 736 may include one or both of system storage that is provided integrally (i.e., substantially non-removable) with server(s) 702 and/or removable storage that is removably connectable to server(s) 702 via, for example, a port (e.g., a USB port, a firewire port, etc.) or a drive (e.g., a disk drive, etc.). Electronic storage 736 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 736 may include one or more virtual storage resources (e.g., cloud storage, a virtual private network, and/or other virtual storage resources). Electronic storage 736 may store software algorithms, information determined by processor(s) 738, information received from server(s) 702, information received from client computing platform(s) 704, and/or other information that enables server(s) 702 to function as described herein.

Processor(s) 738 may be configured to provide information processing capabilities in server(s) 702. As such, processor(s) 738 may include one or more of a digital processor, an analog processor, a digital circuit designed to process information, an analog circuit designed to process information, a state machine, and/or other mechanisms for electronically processing information. Although processor(s) 738 is shown in FIG. 7 as a single entity, this is for illustrative purposes only. In some implementations, processor(s) 738 may include a plurality of processing units. These processing units may be physically located within the same device, or processor(s) 738 may represent processing functionality of a plurality of devices operating in coordination. Processor(s) 738 may be configured to execute modules 708, 710, 712, 714, 716, 718, 720, 722, 724, 726, 728, 730, and/or 732, and/or other modules. Processor(s) 738 may be configured to execute modules 708, 710, 712, 714, 716, 718, 720, 722, 724, 726, 728, 730, and/or 732, and/or other modules by software; hardware; firmware; some combination of software, hardware, and/or firmware; and/or other mechanisms for configuring processing capabilities on processor(s) 738. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 708, 710, 712, 714, 716, 718, 720, 722, 724, 726, 728, 730, and/or 732 are illustrated in FIG. 7 as being implemented within a single processing unit, in implementations in which processor(s) 738 includes multiple processing units, one or more of modules 708, 710, 712, 714, 716, 718, 720, 722, 724, 726, 728, 730, and/or 732 may be implemented remotely from the other modules. The description of the functionality provided by the different modules 708, 710, 712, 714, 716, 718, 720, 722, 724, 726, 728, 730, and/or 732 described below is for illustrative purposes, and is not intended to be limiting, as any of modules 708, 710, 712, 714, 716, 718, 720, 722, 724, 726, 728, 730, and/or 732 may provide more or less functionality than is described. For example, one or more of modules 708, 710, 712, 714, 716, 718, 720, 722, 724, 726, 728, 730, and/or 732 may be eliminated, and some or all of its functionality may be provided by other ones of modules 708, 710, 712, 714, 716, 718, 720, 722, 724, 726, 728, 730, and/or 732. As another example, processor(s) 738 may be configured to execute one or more additional modules that may perform some or all of the functionality attributed below to one of modules 708, 710, 712, 714, 716, 718, 720, 722, 724, 726, 728, 730, and/or 732.

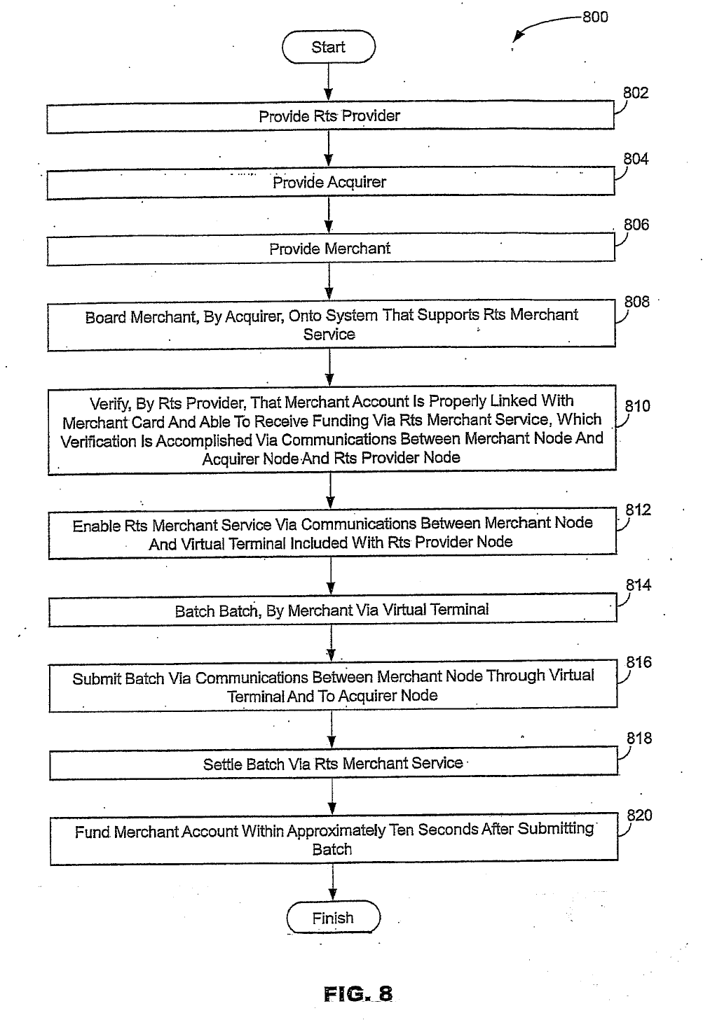

FIG. 8 illustrates a method 800 for real-time settlement of a credit card batch transaction, in accordance with one or more implementations. The operations of method 800 presented below are intended to be illustrative. In some implementations, method 800 may be accomplished with one or more additional operations not described, and/or without one or more of the operations discussed. Additionally, the order in which the operations of method 800 are illustrated in FIG. 8 and described below is not intended to be limiting.

In some implementations, method 800 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 800 in response to instructions stored electronically on an electronic storage medium. The one or more processing devices may include one or more devices configured through hardware, firmware, and/or software to be specifically designed for execution of one or more of the operations of method 800.

An operation 802 may include providing an RTS provider. The RTS provider may operate an RTS provider node that is operably connected to an acquirer node and that is operably connected to a merchant node and includes a virtual terminal and operates an RTS merchant service. Operation 802 may be performed by one or more hardware processors configured by machine-readable instructions including a module that is the same as or similar to rt provider providing module 708, in accordance with one or more implementations.

An operation 804 may include providing an acquirer. The acquirer may operate the acquirer node. Operation 804 may be performed by one or more hardware processors configured by machine-readable instructions including a module that is the same as or similar to acquirer providing module 710, in accordance with one or more implementations.

An operation 806 may include providing a merchant. The merchant may operate a payment terminal and has a merchant account linked to a merchant card and operates the merchant node. Operation 806 may be performed by one or more hardware processors configured by machine-readable instructions including a module that is the same as or similar to merchant providing module 712, in accordance with one or more implementations.

An operation 808 may include boarding the merchant, by the acquirer, onto a system that supports the RTS merchant service. Operation 808 may be performed by one or more hardware processors configured by machine-readable instructions including a module that is the same as or similar to merchant boarding module 714, in accordance with one or more implementations.

An operation 810 may include verifying, by the RTS provider, that the merchant account is properly linked with the merchant card and able to receive funding via the RTS merchant service, which verification is accomplished via communications between the merchant node and the acquirer node and the RTS provider node. Operation 810 may be performed by one or more hardware processors configured by machine-readable instructions including a module that is the same as or similar to merchant account verification module 716, in accordance with one or more implementations.

An operation 812 may include enabling the RTS merchant service via communications between the merchant node and the virtual terminal included with the RTS provider node. Operation 812 may be performed by one or more hardware processors configured by machine-readable instructions including a module that is the same as or similar to rt merchant service enabling module 718, in accordance with one or more implementations.

An operation 814 may include batching a batch, by the merchant via the virtual terminal. Operation 814 may be performed by one or more hardware processors configured by machine-readable instructions including a module that is the same as or similar to batch batching module 720, in accordance with one or more implementations.

An operation 816 may include submitting the batch via communications between the merchant node through the virtual terminal and to the acquirer node. Operation 816 may be performed by one or more hardware processors configured by machine-readable instructions including a module that is the same as or similar to batch submitting module 722, in accordance with one or more implementations.

An operation 818 may include settling the batch via the RTS merchant service. Operation 818 may be performed by one or more hardware processors configured by machine-readable instructions including a module that is the same as or similar to batch settling module 724, in accordance with one or more implementations.

An operation 820 may include funding the merchant account within approximately ten seconds after the submitting the batch. Operation 820 may be performed by one or more hardware processors configured by machine-readable instructions including a module that is the same as or similar to merchant account funding module 726, in accordance with one or more implementations.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

The subject invention may be more easily comprehended by reference to the specific embodiments recited herein, which are representative of the invention. However, it must be understood that the specific embodiments are provided only for the purpose of illustration, and that the invention may be practiced in a manner separate from what is specifically illustrated without departing from its scope and spirit.

What is claimed and desired to be secured by United States Letters Patent is:

1. A method for funding merchants comprising:
providing an RTS provider, wherein the RTS provider operates an RTS provider node that is operably connected to an acquirer node and that is operably connected to a merchant node and includes a virtual terminal and operates an RTS merchant service;
providing an acquirer, wherein the acquirer operates the acquirer node;
providing a merchant, wherein the merchant operates a payment terminal and has a merchant account linked to a merchant card and operates the merchant node;
boarding the merchant, by the acquirer, onto a system that supports the RTS merchant service;
verifying, by the RTS provider, that the merchant account is properly linked with the merchant card and able to receive funding via the RTS merchant service, which verification is accomplished via communications between the merchant node and the acquirer node and the RTS provider node;
enabling the RTS merchant service via communications between the merchant node and the virtual terminal included with the RTS provider node;
batching a batch, by the merchant via the virtual terminal;
submitting the batch via communications between the merchant node through the virtual terminal and to the acquirer node;
settling the batch via the RTS merchant service; and
funding the merchant account within approximately ten (10) seconds after the submitting the batch.

2. The method of claim 1, further comprising:
pre-boarding the merchant, before boarding the merchant and by the acquirer, and verifying that the RTS merchant service is available to the merchant and performing at least one anti-fraud check against the merchant.

3. The method of claim 1, wherein the batch is comprised of multiple credit card transactions to be settled.

4. The method of claim 3, further comprising:
settling a first portion of the batch via the RTS merchant service;
funding the first portion of the batch to the merchant account within approximately ten (10) seconds of the submitting the batch;
settling a second portion of the batch via a traditional settlement process; and
funding the second portion of the batch to the merchant account between approximately two to three (2-3) days of the submitting the batch.

5. A real-time settlement (RTS) system to process payment card batches, comprising:
an RTS provider node comprising an RTS processor and an RTS memory;
an RTS virtual terminal comprising instructions stored in the RTS memory and executed by the RTS processor so as to be able to perform the steps of:
obtaining, by the RTS virtual terminal from a merchant node, a merchant account and a batch of payment card transactions to be settled;
sorting, by the RTS virtual terminal, the batch of payment card transactions into an RTS batch and an ACH batch;
transmitting, by the RTS virtual terminal to an acquirer node, a first request to settle the RTS batch via RTS rails and settling the RTS batch to acquire RTS settlement funds; and
funding, by the RTS virtual terminal via the acquirer node, the merchant account with the RTS settlement funds within approximately ten (10) seconds of the obtaining.

6. The system of claim 5, further comprising:
transmitting, by the RTS virtual terminal to the acquirer node, a second request to settle the ACH batch via ACH rails and settling the ACH batch to acquire ACH settlement funds; and
funding, by the RTS virtual terminal via the acquirer node, the merchant account with the ACH settlement funds between approximately two to three (2-3) days of the obtaining.

7. The system of claim 6, further comprising:
receiving, by the virtual terminal from the acquirer node, merchant information including at least one of the merchant account and a merchant funding instrument;
evaluating, by the RTS virtual terminal through the acquirer node, whether the merchant information will facilitate settlement payments via the RTS system; and
enabling, by the RTS virtual terminal through the acquirer module, the funding of the merchant account via the RTS system.

8. The system of claim 7, wherein the evaluating further comprises running at least one anti-fraud check against the merchant information.

9. The system of claim 5, wherein the RTS virtual terminal is further able to perform the steps of:
receiving, from a merchant node, the payment card transactions; and
batching the payment card transactions according to at least one of the date of the payment card transaction, the amount of the payment card transaction, and the type of the payment card transaction.

10. A real-time settlement (RTS) system for processing payment card batches, comprising:
an RTS provider node comprising an RTS processor and an RTS memory;
an RTS virtual terminal comprising instructions stored in the RTS memory and executed by the RTS processor so as to be able to perform the steps of:
communicating with an acquirer node;
communicating with a merchant node;
receiving, by the RTS virtual terminal from the merchant node through the acquirer node, merchant information comprising a merchant account and a merchant card;
evaluating, by the RTS virtual terminal through the acquirer node, whether the merchant information will support settlement of a payment card transaction via an RTS rail;
enabling, by the RTS virtual terminal through the acquirer node, settlement and funding of a payment card transaction via the RTS system;
obtaining, by the RTS virtual terminal from the merchant node, the merchant account and a batch of payment card transactions to be settled;
sorting, by the RTS virtual terminal, the batch of payment card transactions into an RTS batch and an ACH batch;
transmitting, by the RTS virtual terminal to the acquirer node, a first request to settle the RTS batch via RTS rails and settling the RTS batch to acquire RTS settlement funds;
funding, by the RTS virtual terminal through the acquirer node, the merchant account with the RTS settlement funds within approximately ten (10) seconds of the obtaining.

11. The system of claim 10, further comprising:
transmitting, by the RTS virtual terminal to the acquirer node, a second request to settle the ACH batch via ACH rails and settling the ACH batch to acquire ACH settlement funds; and
funding, by the RTS virtual terminal via the acquirer node, the merchant account with the ACH settlement funds between approximately two to three (2-3) days of the obtaining.

12. The system of claim 11, wherein the RTS virtual terminal is further able to perform the steps of:
receiving, by the RTS virtual terminal from the merchant node, the payment card transactions; and
batching the payment card transactions, by the RTS virtual terminal, according to at least one of the date of the payment card transaction, the amount of the payment card transaction, and the type of the payment card transaction.

13. The system of claim 11, further comprising;
comparing, by the RTS virtual terminal through the acquirer node, the merchant information against a BIN database.

14. The system of claim 12, wherein the evaluating further comprises running at least one anti-fraud check against the merchant information.
